(19) United States
(12) Patent Application Publication
(10) Pub. No.: US 2013/0292954 A1
(43) Pub. Date: Nov. 7, 2013

(54) LEVER HANDLE LOCK FOR CASEMENT DOORS AND WINDOWS

(71) Applicant: Gongchun ZHANG, Guangzhou City (CN)

(72) Inventor: Gongchun ZHANG, Guangzhou City (CN)

(73) Assignee: CMECH (GUANGZHOU) INDUSTRIAL LTD.

(21) Appl. No.: 13/561,207

(22) Filed: Jul. 30, 2012

(30) Foreign Application Priority Data
May 2, 2012 (CN) 201220194441.6

(51) Int. Cl. E05C 1/06

(52) U.S. Cl. 292/33

(57) ABSTRACT

The present invention discloses a lever handle lock for casement doors and windows, which comprises a first and second lock bodies symmetrically installed at either side of the doors or windows. The first lock body features a first lever handle and a thumb-turn while the second lock body features a second lever handle. The first lock body features a latch bolt locking set and a deadbolt locking set, wherein said latch bolt locking set comprises a locking component and a latch bolt component. Said locking component comprises a spindle connected with the second lever handle; a rotatable member connected with the first lever handle and indirectly with the second lever handle, featuring an upper and lower protrudent blocks, wherein the upper protrudent block associates with the latch bolt component; And a torsion spring sleeved on the axle of the rotatable member.

### TECHNICAL FIELD

The present invention relates to a lever handle lock for doors and windows, categorized in anti-theft locking apparatus technology for doors and windows. In particular, it relates to a structurally improved lever handle lock for casement doors and windows.

### BACKGROUND

In prior art, locks for doors and windows are made in various types and functions, including conventional mortise locks and cylindrical locks which are both characterized by simple structure, low production cost and low market price. Nonetheless, these locks are also known to possess a number of drawbacks. The installation of a mortise lock will cause damage to the door structure as a cavity must be cut out on a side edge of the door to allow the bolts to extend. The installation is generally labor intensive and time-consuming, and will weaken the structure of the door. The installation of a cylindrical lock will damage the door structure and offers low security because of its single bolt structure. Even though existing locks for casement doors and windows, e.g. the lock of Chinese patent ZL02225564.8, are able to avoid damage to the door structure by operating locking function through rotation of lever handles. This lock can only be operated inside the windows, and completely rely on the lever handles to open or close the window. It is inconvenient to use and restricted in many areas.

Therefore, the applicant made improvements on the locks for casement doors and windows and filed the Chinese Utility Model patent ZL201020026398.3. Said patent discloses a lever handle lock for casement doors and windows that is easy to operate and provides higher security. The present invention is a new improvement based upon the technical solutions of said Utility Model patent.

### SUMMARY

In order to overcome the defects and drawbacks in the prior art, the present invention provides a structurally improved lever handle lock for casement doors and windows characterized by compact structure, easy assembly, prompt alteration of direction, low cost and long lifetime.

To achieve the above objective, the present invention adopts technical solutions described below:

A lever handle lock for casement doors and windows comprises a first lock body and a second lock body which are symmetrically installed at either side of the doors or windows. The first lock body features a first lever handle and a thumb-turn, while the second lock body features a second lever handle. The first lock body features a latch bolt locking set and a deadbolt locking set, wherein said latch bolt locking set comprises a locking component and a latch bolt component which are interconnected to each other. Said locking component comprises a spindle connected firmly with the second lever handle; a rotatable member, which is connected firmly with the first lever handle and indirectly with the second lever handle by virtue of spindle, said rotatable member also has an upper protrudent block and a lower protrudent block in its upper end and lower end respectively, the upper protrudent block associates with the latch bolt component; and a torsion spring sleeved on the axle of rotatable member, features two downward extended strips which compress on the opposing sides of the positioning rod located in the first lock body.

Furthermore, said latch bolt component comprises a latch bolt which is installed inside the first lock body and can be extended and retracted inside the first lock body, whose bevelled head protrudes out of the first lock body while the crooked supporting feet at the opposite end associates with the rotatable member of locking component; a return spring, whose ends compress on the latch bolt and a positioning screw in the first lock body respectively.

Furthermore, said first lock body features two slots symmetrically located at both sides of the lock body to allow the extension of the latch bolt, and said latch bolt component also comprises a latch bolt direction-alteration bracket, which is adjustable and fixed between the latch bolt slots to conceal the latch bolt component into the first lock body. The direction-alteration bracket has an opening corresponding to the latch bolt slot and a closure plate concealing the latch bolt slot at the opposite side.

Furthermore, said locking component also comprises a pressboard, which snaps on the first lock body and conceals the locking component into the first lock body.

Furthermore, said deadbolt locking set comprises a deadbolt which is installed in the first lock body and can be extended and retracted inside the first lock body, and features two irregular notches symmetrically located at opposite end of the extended end of the deadbolt; A deadbolt rotator, which is connected firmly with thumb-turn of the first lock body and penetrates through one end of the deadbolt, and the deadbolt rotator features a positioning disc which has a protrudent rod that is embedded into the said deadbolt irregular notch so as to bring the deadbolt to extend or retract.

Furthermore, a first straight ridge and a second straight ridge are linked by a curvy ridge at the same side of the protrudent rod on the positioning disc; And said deadbolt locking set also comprises a positioning strip, which in turn compresses on the first and the second straight ridge on the positioning disc when the deadbolt extending or retracting.

Furthermore, said first lock body features two deadbolt slots symmetrically located at both sides of the lock body to allow the extension of the deadbolt. Said deadbolt locking set also comprises a deadbolt direction-alteration bracket, which is adjustable and fixed between the deadbolt slots to conceal the deadbolt and its rotator into the first lock body. The direction-alteration bracket has an opening corresponding to the deadbolt slot and a closure plate at the opposite side concealing the deadbolt slot.

Furthermore, said first lock body also comprises a restraint strip whose two terminals grip on the screw columns in the first lock body so as to restrain the latch bolt locking set and the deadbolt locking set into the first lock body.

Compared with the prior art, the present invention has the following advantages and benefits:
1. simple and compact structure, easy and convenient assembly, easy operation of door opening and closing, high security;
2. having bolt slots at both sides of the lock body enables convenient direction-alteration of the lock bolts, which meets the installation requirements for casement doors and windows that open inward, or outward, to the left or right, and is more versatile and lower cost;

Embodiments of the present invention will now be described in details with reference to the following figures.

### BRIEF DESCRIPTION OF DRAWINGS

FIG. 1 is a schematic diagram for a left-open lever handle lock of the present invention.

FIG. 2 is the exploded drawing of FIG. 1.

FIG. 3 is the structure schematic diagram of the first lock body in FIG. 1.

FIG. 4 is the structure schematic diagram of a right-open lever handle lock of the present invention.

### DETAILED DESCRIPTION

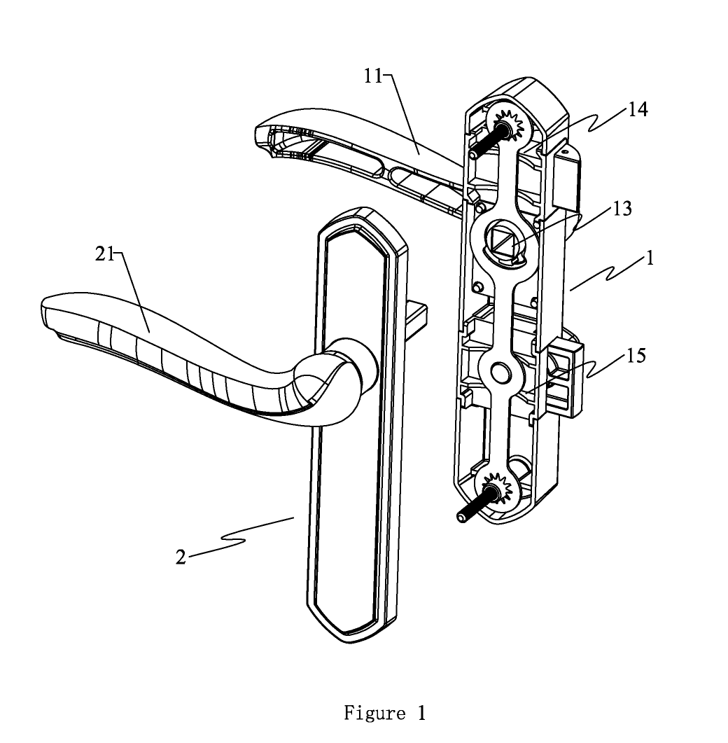

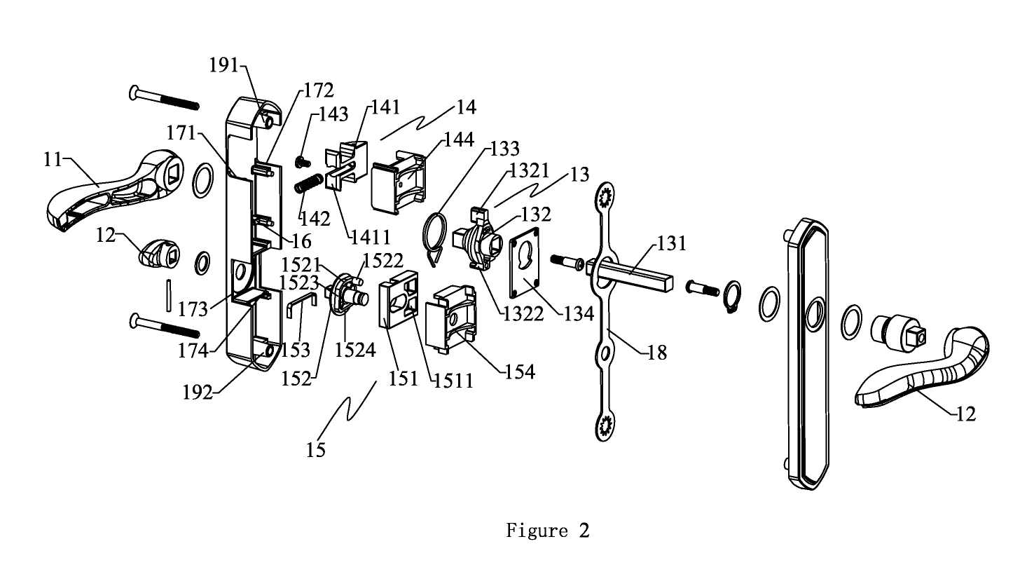

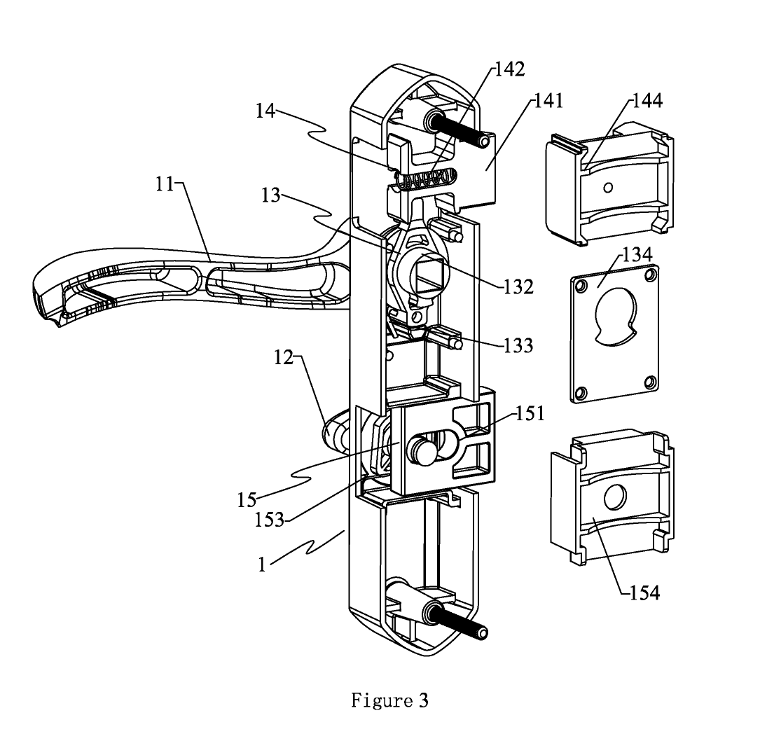

Referring to FIGS. 1 to 3, a left-open lever handle lock for casement doors and windows comprises a first lock body and a second lock body which are symmetrically installed at either side of the doors or windows. The first lock body features a first lever handle 11 and a thumb-turn 12, while the second lock body features a second lever handle 21. The first lock body 1 features a latch bolt locking set and a deadbolt locking set 15, wherein said latch bolt locking set comprises a locking component 13 and the latch bolt component 14 which are interconnected to each other.

Said locking component 13 comprises spindle 131 connected firmly with the second lever handle 21; rotatable member 132, which is connected firmly with the first lever handle 11, and indirectly with the second lever handle 21 by virtue of spindle 131, the rotatable member 132 also an upper protrudent block 1321 and a lower protrudent block 1322 in its upper end and lower end respectively, the upper protrudent block 1321 associates with the latch bolt component; and torsion spring 133 sleeved on the axle of the rotatable member 132, features two downward extended strips which compress on the opposing sides of the positioning rod 16 located in the first lock body.

Said latch bolt component 14 comprises latch bolt 141 which is installed inside the first lock body 1 and can be extended and retracted inside the first lock body 1, whose bevelled head protrudes out of the first lock body while the crooked supporting feet 1411 at the opposite end associates with the rotatable member of locking component; a return spring 142, whose ends compress on the latch bolt 141, and a positioning screw 143 in the first lock body respectively.

Furthermore, said first lock body 1 features two slots 171, 172 symmetrically located at both sides of the lock body to allow the extension of the latch bolt. Said latch bolt component also comprises a latch bolt direction-alternation bracket 144, which is adjustable and fixed between the latch bolt slots to conceal the latch bolt component into the first lock body. The direction-alteration bracket 144 features an opening corresponding to the latch bolt slot and a closure plate at the opposite slot. Preferably, said locking component 13 also comprises a pressboard 134, which snaps on the first lock body and conceals the locking component into the first lock body 1.

Said deadbolt locking set 15 comprises a deadbolt 151 which is installed in the first lock body and can be extended and retracted inside the first lock body 1, and features two irregular notches 1511 symmetrically located at the opposite end of the extended end of the deadbolt; A deadbolt rotator 152, which is connected firmly with a thumb-turn 12 of the first lock body 1 and penetrates through one end of the deadbolt 151, and the deadbolt rotator 152 features a positioning disc 1521 which has a protrudent rod 1522 that is embedded into the said deadbolt irregular notch 1511 so as to bring the deadbolt 151 to extend or retract, 1 features a first straight ridge 1523 and a second straight ridge 1524 are linked by a curvy ridge at the same side of the protrudent rod 1522 on the positioning disc 1521, which are linked by a smooth curve; And a positioning spring strip 153, which in turn compresses on the first straight ridge 1523 and the second straight ridge 1524 on the positioning disc 1521 when the deadbolt extending or retracting.

Furthermore, said first lock body 1 features two deadbolt slots 173, 174 symmetrically located at both sides of the lock body to allow the extension of the deadbolt. Said deadbolt locking set 15 also comprises a deadbolt direction-alteration bracket 154, which is adjustable and fixed between the deadbolt slots to conceal the deadbolt and its rotator into the first lock body 1. The direction-alteration bracket 154 has an opening corresponding to the deadbolt slot and a closure plate at the opposite side concealing the deadbolt slot.

According to the preferred embodiment, said first lock body also comprises a restraint strip 18 whose terminals grip on the screw columns 191, 192 so as to restrain the latch bolt locking set and the deadbolt locking set into the first lock body 1.

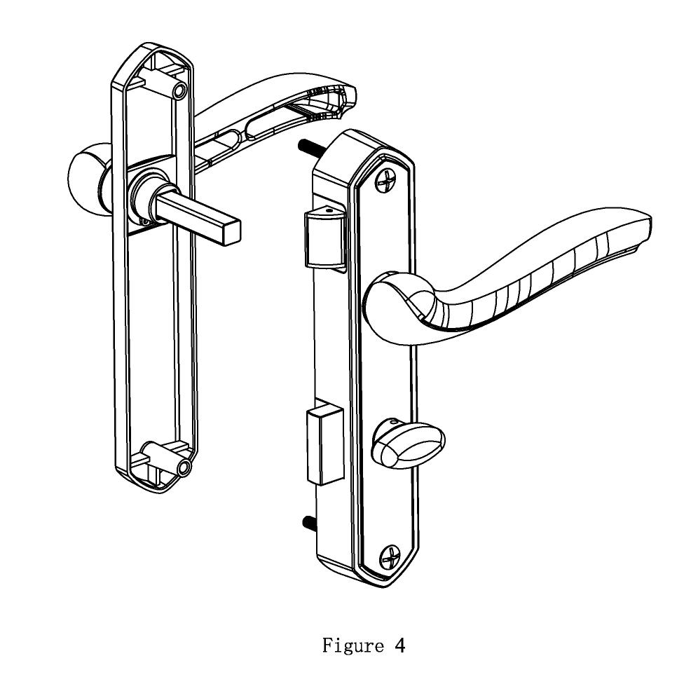

Referring to FIG. 4, a right-open lever handle lock for casement doors and windows is obtained by changing the installing directions of the latch bolt and the latch bolt direction-alteration bracket, deadbolt and the deadbolt direction-alteration bracket, as well as the first and the second lever handles.

The present invention is not limited to the above-mentioned embodiment. The present invention also includes alterations or variations that do not depart from the spirit and scope thereof, and fall within the scope of the appended claims and their equivalents.

1. A lever handle lock for casement doors and windows, comprising a first lock body and a second lock body which are symmetrically installed at either side of the doors or windows, the first lock body features a first lever handle and a thumb-turn, while the second lock body features a second lever handle the first lock body features a latch bolt locking set and a deadbolt locking set, wherein said latch bolt locking set comprises a locking component and a latch bolt component which are interconnected to each other, and said locking component comprises:
a spindle connected firmly with the second lever handle;
a rotatable member, which is connected firmly with the first lever handle and indirectly with the second lever handle by virtue of spindle, said rotatable member features an upper protrudent block and a lower protrudent block on its upper end and lower end respectively, the upper protrudent block associates with the latch bolt component; and
a torsion spring, which is sleeved on the axle of rotatable member, features two downward extended strips which compress on the opposing sides of the positioning rod located in the first lock body respectively.

2. The lever handle lock for casement doors and windows according to claim 1, wherein said latch bolt component comprises:
a latch bolt which is installed and can be extended and retracted inside the first lock body, whose bevelled head protrudes out of the first lock body while the crooked supporting feet at its opposite end associates with the rotatable member of the locking component; and
a return spring, whose ends respectively compress on the latch bolt and a positioning screw in the first lock body.

3. The lever handle lock for casement doors and windows according to claim 2, wherein said first lock body features two slots symmetrically located at both sides of the lock body to allow the extension of the latch bolt, and said latch bolt component also comprises a latch bolt direction-alteration bracket, which is adjustable and fixed between the latch bolt slots to conceal the latch bolt component into the first lock body, the direction-alteration bracket has an opening corresponding to the latch bolt slot and a closure plate at the opposite side concealing the latch bolt slot.

4. The lever handle lock for casement doors and windows according to claim 2, wherein said locking component comprises a pressboard, which snaps on the first lock body and conceals the locking component into the first lock body.

5. The lever handle lock for casement doors and windows according to claim 1, wherein said deadbolt locking set comprises:
a deadbolt which is installed in the first lock body and can be extended and retracted inside the first lock body, and features two irregular notches symmetrically located at the opposite end of the extended end of the deadbolt; and
a deadbolt rotator, which is connected firmly with thumb-turn of the first lock body and penetrates through one end of the deadbolt, and said deadbolt rotator features a positioning disc with a protrudent rod that is embedded into the said deadbolt irregular notch so as to bring the deadbolt to extend or retract.

6. The lever handle lock for casement doors and windows according to claim 5, wherein a first straight ridge and a second straight ridge are linked by a curvy ridge at the same side of the protrudent rod on the positioning disc, and said deadbolt locking set also comprises a positioning strip which in turn compresses on the first and the second straight ridge on the positioning disc when the deadbolt is extending or retracting.

7. The lever handle lock for casement doors and windows according to claim 5, wherein said first lock body features two deadbolt slots symmetrically located at both sides of the lock body to allow the extension of the deadbolt, said deadbolt locking set also comprises a deadbolt direction-alternation bracket, which is adjustable and fixed between the deadbolt slots to conceal the deadbolt and deadbolt rotator into the first lock body; The direction-alternation bracket features an opening corresponding to the deadbolt slot at one side and a closure plate concealing deadbolt slot at the opposite side.

8. The lever handle lock for casement doors and windows according to claim 1, wherein said first lock body comprises a restraint strip whose two terminals grip on the screw columns in the first lock body, and restrains the latch bolt locking set and the deadbolt locking set into the first lock body.
